(19) United States
(12) Patent Application Publication
(10) Pub. No.: US 2014/0244556 A1
(43) Pub. Date: Aug. 28, 2014

(54) METHODS FOR AND APPARATUS GENERATING AUTOMATED PHARMACO GENETICS CORRELATION

(71) Applicants: Abdul Saleh, Santa Cruz, CA (US); Fabian Ortiz, Jacksonville, FL (US)

(72) Inventors: Abdul Saleh, Santa Cruz, CA (US); Fabian Ortiz, Jacksonville, FL (US)

(21) Appl. No.: 13/779,699

(22) Filed: Feb. 27, 2013

(51) Int. Cl. G06N 3/12

(52) U.S. Cl. CPC G06N 3/126
USPC 706/13

(57) ABSTRACT

The present invention provides methods and apparatus for generating human readable output with a correlation between one or more genetic traits and one or more medicaments.

### FIELD OF THE INVENTION

The present invention relates to methods and apparatus of generating automated pharmaco genetic correlation. More specifically, the present invention relates to generating data descriptive of specific genetic traits and the correlation of those traits with one or more medicaments or ingestible substance.

### BACKGROUND OF THE INVENTION

Analysis of human DNA has been known which allows an individual to associate particular genetic traits with an indication of how the individual will process a particular medicament. Generally, genetic testing is available which analyzes a particular gene, such as Gene P405 CYP2C19 and indicates whether an individual has a gene mutation for the Gene P405 CYP2C19 which will affect the individual's ability to process the particular medicament.

Such tests were done on a per request basis for a particular individual and a particular medicament. The expense was substantial and relatively time consuming.

More recently, multiple genetic tests have been conducted simultaneously for an individual on a per request basis. However, prior to the present invention, there has not been a mechanism for generating a comprehensive representation of genetic correlation with medicaments for a significant number of people.

### SUMMARY OF THE INVENTION

Accordingly, the present invention provides methods and apparatus for generating a comprehensive representation of genetic correlation with medicaments for a significant number of people. In some embodiments, a processor in conjunction with executable software, aggregates a database of genetic information descriptive of both copies of genes of multiple individuals to determine allele whether the gene copies are: Ultra metabolized, normal or nonfunctional in relation to a particular medicament or other substance which may enter the bloodstream of the individual.

### BRIEF DESCRIPTION OF THE DRAWINGS

As presented herein, various embodiments of the present invention will be described, followed by some specific examples of various components that can be utilized to implement the embodiments. The following drawings facilitate the description of some embodiments:

FIG. 1 illustrates a distributed network on which aspects of the present invention may be implemented.

FIG. 2 illustrates exemplary steps that may be implemented in practicing some embodiments of the present invention.

FIG. 3 illustrates an exemplary of logon screen that may be used in some implementations of the present invention.

FIGS. 4-6 illustrate exemplary graphical user interface (GUI) screens that may be used in some implementations of the present invention.

FIG. 7 illustrates apparatus on which aspects of the present invention may be implemented.

### DETAILED DESCRIPTION OF PREFERRED EMBODIMENTS

The present invention provides methods and apparatus which act as an automated “engine” for aggregating genetic analysis. The genetic analysis may include that associates one or more individuals' genetic predisposition to one or more medicaments. The present invention provides such data via automated apparatus to one or more interested parties, such as a health care provider (HCP), a pharmacy, or other interested party. In preferred embodiments, genetic predisposition may be based upon the functionality of particular genes present in an individual.

Genetic analysis may be accomplished, for example, via known processes, such as those available through Affymetrix, Inc. of Santa Clara, Calif. and Ilumina, Inc of San Diego, Calif.

In the present invention a one or more automated servers stores genetic correlation data in a data storage device and makes the data available in real time, or otherwise without artificial delay. Access may be via a distributed network or other data transmission médium.

Data may be provided, for example, via one or more of: functional algorithms; graphs, charts, alphanumeric continuums or other human discernable manner.

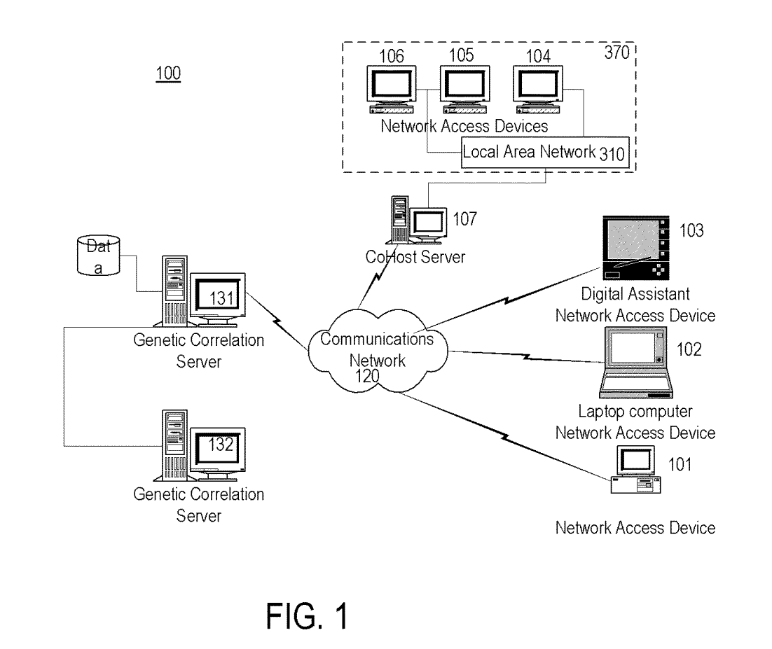

Referring now to FIG. 1 a network of computerized devices 101-107, 131-113 is illustrated that may be used in an implementation of an automated system for facilitating genetic correlation with medicaments. The network 100 includes a genetic correlation server 131 or other host system and one or more network access devices 101-106, such as a personal computer, laptop, personal digital assistant, handheld computer or other wireless device, or other device that provides access to a resource available on a distributed network.

Each network access devices includes a processor, memory, a user input device, such as a keyboard and/or mouse, and a user output device, such as a video display and/or printer. The network access devices 101-106 can communicate with the genetic correlation server 131 to obtain data stored at the genetic correlation server 131. The network access device 101-106 may interact with the genetic correlation server 131 as if the genetic correlation server 131 was a single entity in the network 100. However, the genetic correlation server 131 may include multiple processing and database sub-systems, such as cooperative or redundant processing and/or an additional server 132 that can be geographically dispersed throughout the network 100. In addition, there may be more than one occurrence of a host server 131. In some implementations, groups of network access devices 104-106 may communicate with genetic correlation server 131 through a co-host server 107. The co-host server 107 may be a proxy server or a caching server.

A genetic correlation server 131 may include one or more databases 345 which can store data relating to a patients, genetic correlations, medicaments, chemicals found in the blood and other related information. A database 145 can be a relational database, a hierarchical database or any other structure. A large variety of genetic correlation related information may be stored at the genetic correlation server 131, for example, text, data, charts, audio, video, graphics, animations, and illustrations.

In addition, the genetic correlation server 131 may interact with, and gather data from a user at a network access device 101-106. Data gathered from the user may be used for example include drug interaction advice, medical history, statistical tendencies or other related information.

A user may access a genetic correlation server 131 using client software executed at the user's computer 101-106. The client software may include a generic hypertext markup language (HTML) browser, such as Chrome, Safari or Microsoft Internet Explorer, (a “WEB browser”). The client software may also be a proprietary browser, and/or other host access software. In some cases, an executable program, such as a Java™ program, may be downloaded from the genetic correlation server 131 or another host server to the network access device and executed at the network access device.

The genetic correlation server 131 may receive multiple forms of data as input. For example, the genetic correlation server 131 may receive data descriptive of a genetic correlation candidate 111-114. Data may be received as text input into fields on a form presented on a GUI, or received via an electronic data feed.

The genetic correlation may also be linked to a medical data centralized databank, such as a government or industry databank. The databank may include one or more of: data related to patients and data related to medicaments or other drugs or chemicals.

The invention may be implemented in digital electronic circuitry, or in computer hardware, firmware, software, or in combinations of them. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output. As used herein, an “Engine” may include an apparatus with a processor that executes a software process to receive one or more inputs, process the inputs, and generate an output based upon the inputs. An engine may include one or more servers or be a generated on a server farm.

Preferably the invention will be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors.

Computers 101-107 131-133, in a network 100 utilized to form a genetic correlation candidate investment system may be connected to each other by one or more network interconnection technologies. For example dial-up lines, token-ring and/or Ethernet networks 110, T1 lines, asynchronous transfer mode links, wireless links, cable modems and integrated service digital network (ISDN) connections may all be combined in the communications network 120. Other packet network and point-to-point interconnection technologies may also be used. Additionally, the functions associated with separate processing and database servers in the genetic correlation server 131 may be integrated into a single server system or may be partitioned among servers and database systems that are distributed over a wide geographic area.

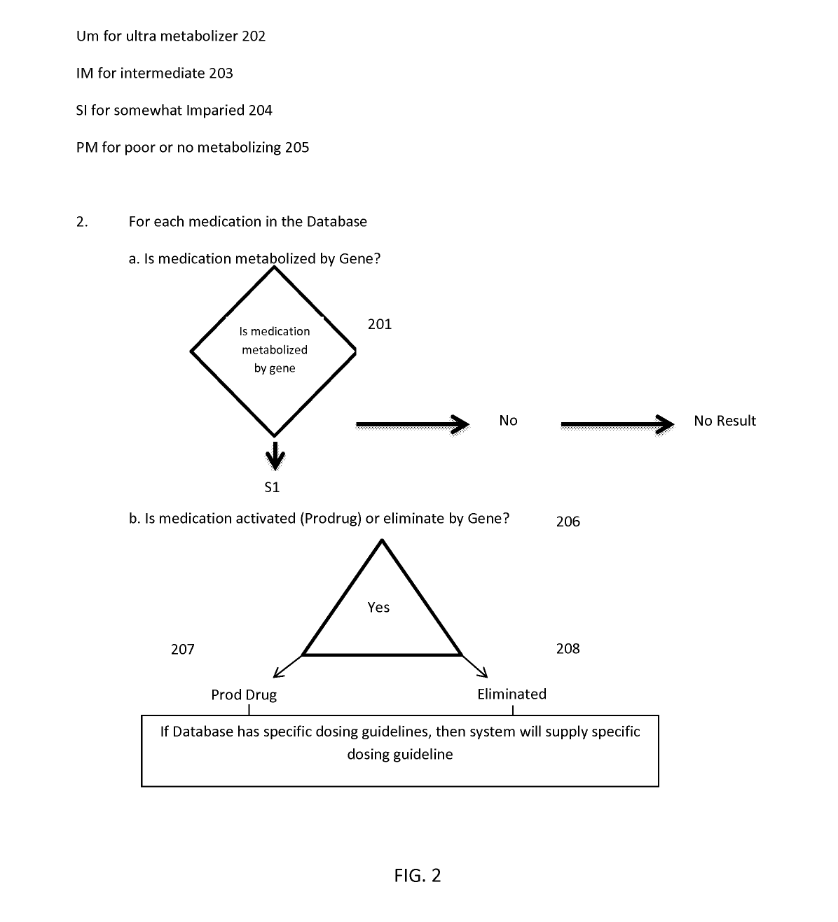

Referring now to FIG. 2, an example of an Interactive Process for Analysis 200 of a human gene is illustrated The process is also available for the genes of other animals, such as horses, dogs or other high value animals for which genetic testing may be suitable. Essentially, the process includes methods steps and functions that may be implemented in their entirety or in part in various implementations of the present invention.

In this included example one gene is considered in particular. Gene P405 CYP2C19. The actual process may be repeated across approximately 2000 genes covered by Pharma EG. In the steps provided, at 201 it is determined for some or all of the medications in the database if the medication is metabolized by the gene. Ratings may be applied to the rate of metabolization, such as for example: Um for ultra metabolizer 202; IM for intermediate 203; SI for somewhat Imparied 204; and PM for poor or no metabolizing 205.

1. Analyze both copies of the genes to determine allele:

| | *17 | *1 | *2 |
|---|---|---|---|
| *17 | UM | IM | NORMAL |
| *1 | IM | NORMAL | SIM |
| *2 | NORMAL | SIM | PM |

*17 = Ultra metabolized
*1 = Normal
*2 = Non functional

In addition, it may be determined and logged if a medication is activated or eliminated by a Gene 206. At 207, a drug is processed and at 208 the drug is eliminated.

| | PRO DRUG | Eliminated |
|---|---|---|
| | If Specific Guideline | If NO Specific Guideline Exists. |
| | Exists | General Dosing Guideline |
| | General Dosing | |
| | Guideline | |
| | ↓ | ↓ |
| UM | Avoid Medication if | Avoid Medication if Possible. |
| | Possible. | If necessary start dose at High end |
| | If necessary, start dose | of range. Monitor for high rates of |
| | at lowest possible dose | elimination and possible need for |
| | and titrate gradually | greater frequency of dosing |
| | upward | |
| IM | Begin dose at lowest | Begin dose at high end of range. |
| | effective range. | Titrate gradually downward |
| | Titrate gradually | |
| | upward | |
| NORMAL | Normal Dose | Normal Dose |
| SIM | Begin Dose at higher | Begin Dose at low end of range |
| | end of range. | Titrate as necessary |
| | Titrate as necessary | |
| IMPAIRED | AVOID | AVOID MEDICATION IF |
| | MEDICATION | POSSIBLE |
| | IF POSSIBLE | Overdose danger is likely. If |
| | Medication will likely | necessary start dosing at lowest |
| | have little or no | possible dose and titrate gradually |
| | function. Higher | upward |
| | dosage may have | |
| | limited effect | |

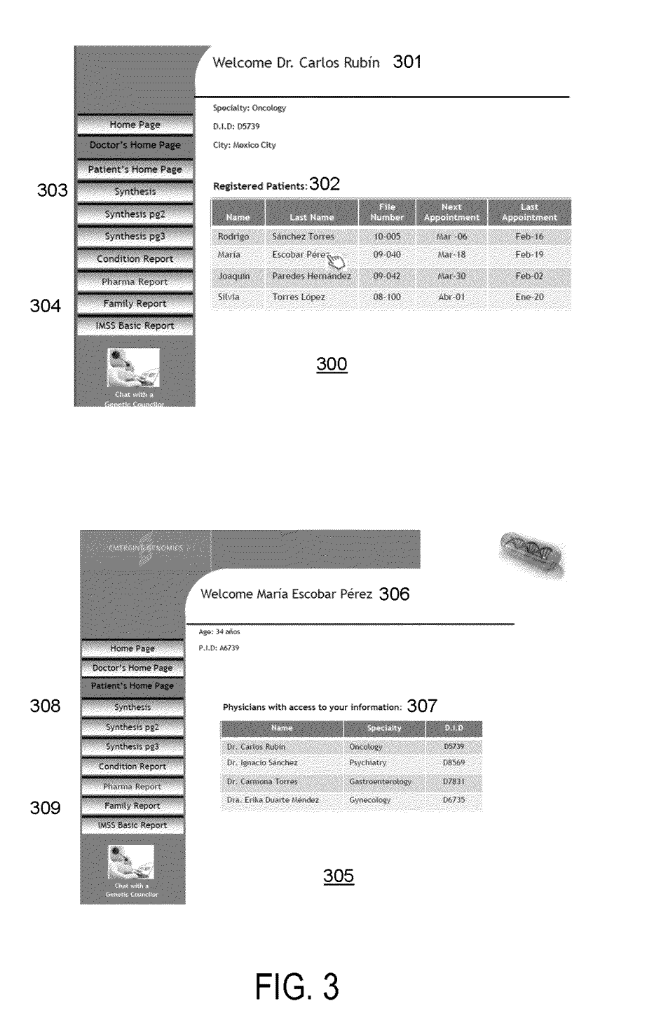

Referring now to FIGS. 3-6, interactive graphical user interfaces (GUI's) that may be used to implement various functions of the present invention are presented. A GUI may be operable in conjunction with a network access device to make functionality associated with the present invention available to a user.

In FIG. 3, a first GUI 300 may be associated with a physician or other health care practitioner 301 and may include a list of patients 302 associated with the health care practitioner 301. The health care practitioner GUI may also include one or more interactive user devices, such as a virtual push button to access Synthesis content 303 and/or a selection of reports 304.

A second GUI illustrated is an exemplary Patient GUI 305. The Patient GUI includes functionality of the present invention that is associated with a particular patient 306. The patient GUI 305 may include a list of health care practitioners 307 associated with the patient 306. The Patient GUI may also include one or more interactive user devices, such as a virtual push button to access Synthesis content 308 and/or a selection of reports 309.

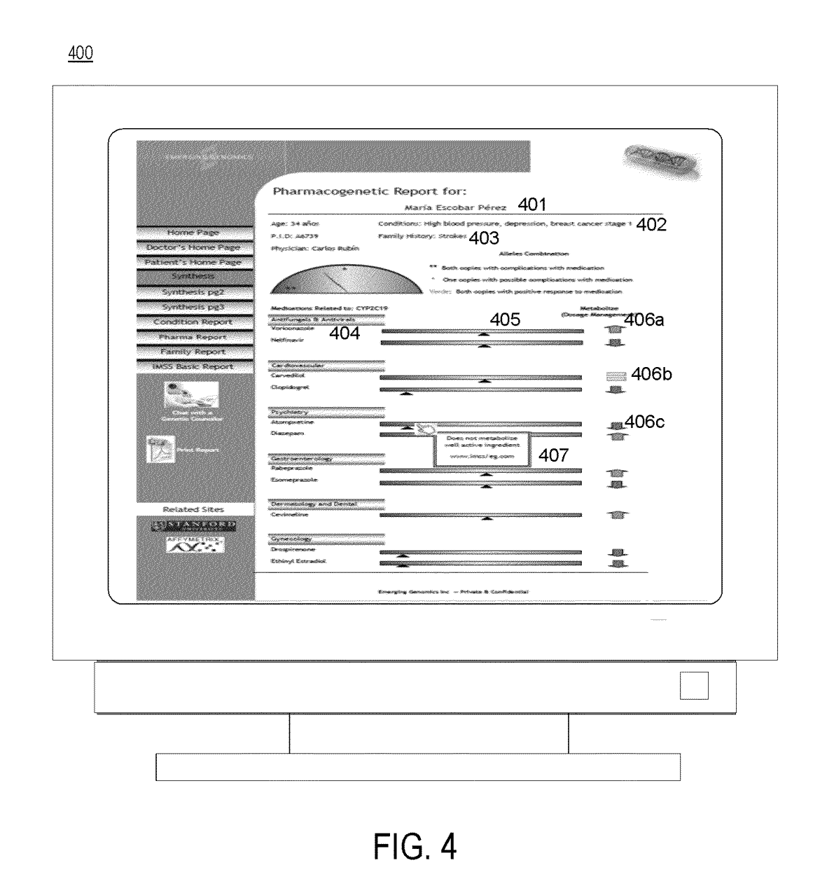

Referring now to FIG. 4, a GUI is presented that is displayable on a network access device and includes a Pharmacogentic Report for a patient 401. The GUI may include patient conditions, the as high blood pressure, depression, cancer or other historical data as well as a family history of conditions 403.

A list of medicaments 404 may be included and a graphical scalar representation 405 of the medicaments 404 suitability with the patient based upon genetic factors. A graphical indicator device 406a-c may also be used to represent compatibility of a medicament 404 with a patient 401. The graphical indicator device 406a-c may include a positive suitability 406a, a neutral suitability 406b and a negative suitability 406c.

In addition, a highlighted representation 407 may be placed in a prominent position within the GUI and give an overall instruction regarding the patient 401 and one or more medicaments.

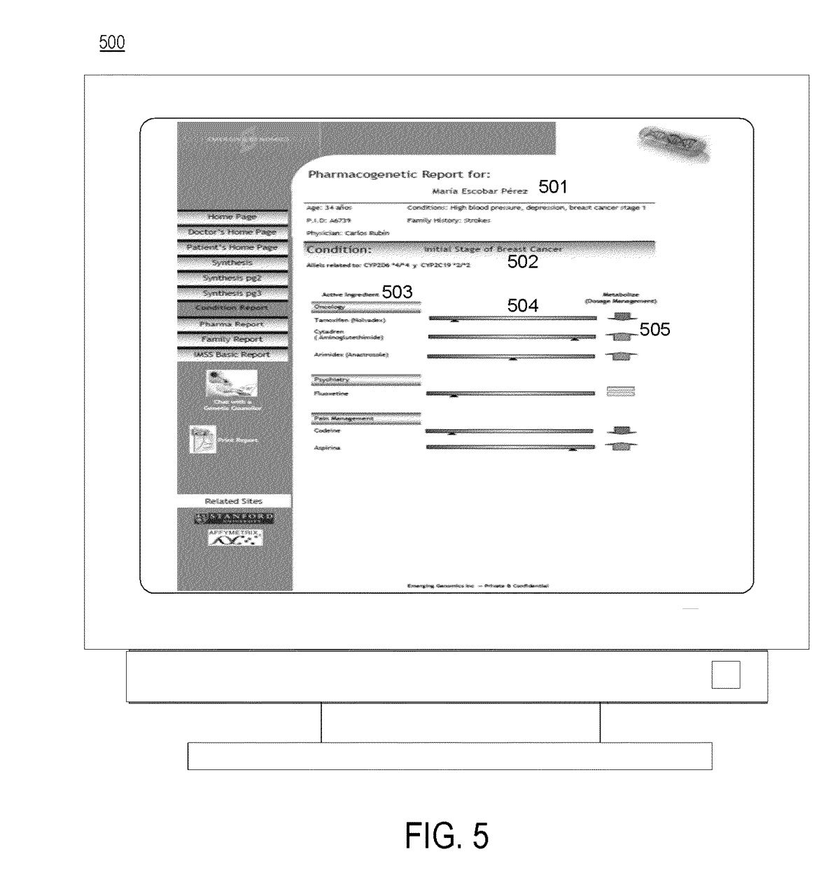

Referring now to FIG. 5, in another exemplary GUI 500, a patient identification 501 may be included. The GUI may include a condition 502 associated with the patient 501. An active ingredient 503 may be identified, and a scalar indication 504 of the compatibility of the active ingredient with the patient 501. The GUI may also include a graphical indicator device 505 may include a positive suitability, a neutral suitability and a negative suitability.

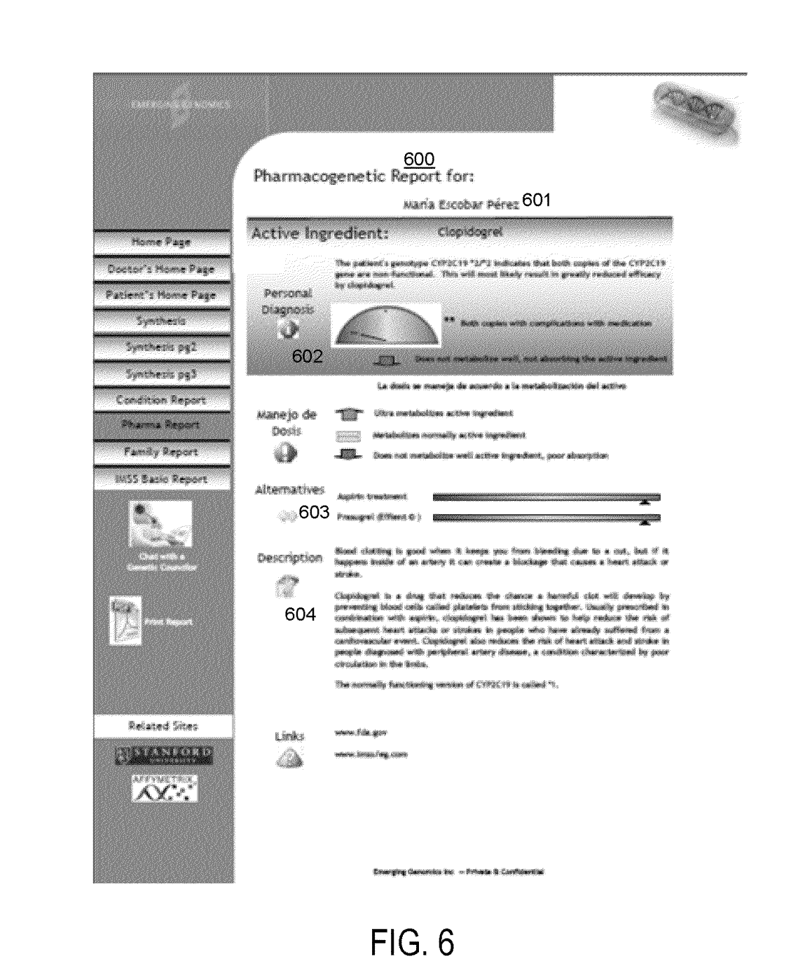

Referring now to FIG. 6, an exemplary GUI with a Pharmacogenetic Report 600 for a patient 601 is illustrated. The Pharmacogenetic Report 600 may include a personal diagnosis of an active ingredient 602. The Personal Diagnosis 602 may include a description of how compatible a patient's genotype is with an active ingredient. The Pharmacogenetic Report 600 may also include one or more alternative treatments 603 and a pharmacogenetic compatibility indication 603. A description of the alternative treatment 604 may also be included which describes a medicament and/or active agent included in the alternative treatment.

Interactive user areas on the display can include: an area for genetic correlation candidate identification, an area relating to genetic traits, an area containing an image of a candidate, an area containing detailed information relating to medicaments and an area for details relating to a completed genetic.

Additional interactive areas that can be incorporated into a GUI according to the present invention include an area to display alternative treatments or medicaments which may be helpful to a health care practitioner in the event that a genetic predisposition indicates that a first medicament is not genetically compatible with a patient.

### Apparatus

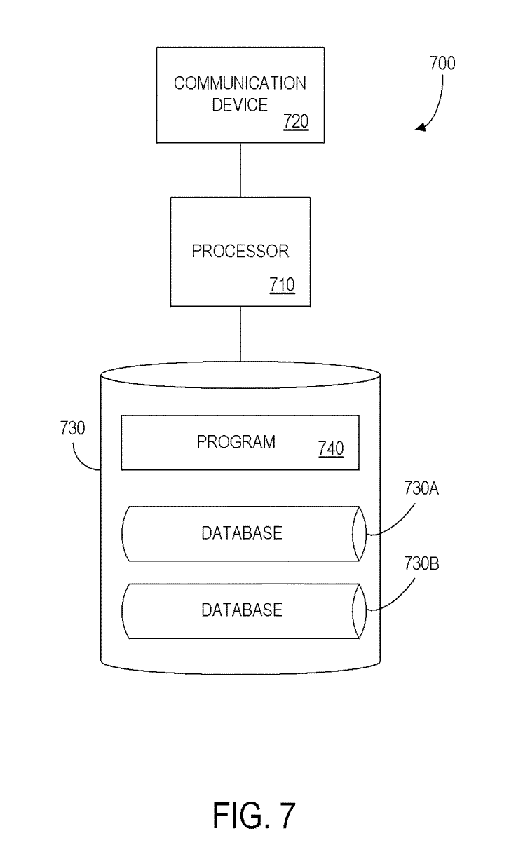

The teachings of the present invention may be implemented with any apparatus capable of embodying the innovative concepts described herein. FIG. 7 illustrates a controller 700 that may be utilized to implement some embodiments of the present invention.

The controller 700 comprises a processor unit 710, such as one or more processors, coupled to a communication device 720 configured to communicate via a communication network (not shown in FIG. 7). The communication device 720 may be used to communicate, for example, with one or more online devices, such as a personal computer, laptop or a handheld device.

The processor 710 is also in communication with a storage device 730. The storage device 730 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 730 can store a program 740 for controlling the processor 710. The processor 710 performs instructions of the program 740, and thereby operates in accordance with the present invention. The processor 710 may also cause the communication device 770 to transmit information, including, in some instances, control commands to operate apparatus to implement the processes described above. The storage device 730 can additionally store related data in a database 730A and database 730B, as needed.

### CONCLUSION

A number of embodiments of the present invention have been described. Nevertheless, it will be understood that various modifications may be made without departing from the spirit and scope of the invention. For example, various methods or equipment may be used to implement the process steps described herein or to create a device according to the inventive concepts provided above and further described in the claims. In addition, various integration of components, as well as software and firmware can be implemented. Accordingly, other embodiments are within the scope of the following claims.

1. Apparatus for providing genetic correlation related to an individual, the apparatus comprising:
a processor operatively attached to a data storage device and executable computer program code stored upon the data storage device, the executable program code executable upon demand to cause the processor to be operative to:
receive data comprising genetic attributes of multiple individuals;
receive data comprising a relationship between a genetic trait and an efficacy of treatment with a medicament;
receive an inquiry related to a first individual; and
provide a human readable output comprising a relationship between the genetic attributes of the first individual and the medicament.

2. The apparatus of claim 1 wherein the executable program code causes the processor to be additionally operative to transmit a graphical user interface comprising an ultra metabolizer rating.

3. The apparatus of claim 1 wherein the genetic attributes comprise Gene P4-5 CYP2C19.

4. The apparatus of claim 1 wherein the genetic attributes comprise one or more genes covered by Pharma EG.

5. The apparatus of claim 1 wherein the human readable output comprises an indication of whether a medication is metabolized by a gene.

6. The apparatus of claim 1 wherein the executable program code causes the processor to be additionally operative to transmit a graphical user interface comprising an intermediate metabolizer rating.

7. The apparatus of claim 1 wherein the executable program code causes the processor to be additionally operative to transmit a graphical user interface comprising rating for poor metabolizing of the medicament.

8. The apparatus of claim 1 wherein the executable program code causes the processor to be additionally operative to transmit a graphical user interface comprising rating for no metabolizing of the medicament.

9. The apparatus of claim 1 wherein the executable program code causes the processor to be additionally operative to transmit a graphical user interface comprising a recommendation for a patient not to take the medicament.

10. The apparatus of claim 1 wherein the executable program code causes the processor to be additionally operative to transmit a graphical user interface comprising a recommendation for a patient to begin a dose at a higher end of range of dosing.

11. The apparatus of claim 1 wherein the executable program code causes the processor to be additionally operative to transmit a graphical user interface comprising a recommendation for a patient to begin a dose at a lower end of range of dosing.

12. The apparatus of claim 1 wherein the executable software additionally causes the processor to receive data related to an experience of a population comprising multiple individuals with a particular medicament and associate a genetic trait present in the population with the experience.

13. The apparatus of claim 12 wherein the experience with the medicament comprises an adverse event.

14. Apparatus for providing genetic correlation related to an individual, the apparatus comprising:
a processor operatively attached to a data storage device and executable computer program code stored upon the data storage device, the executable program code executable upon demand to cause the processor to:
receive data comprising genetic attributes of multiple individuals;
receive data comprising a relationship between a genetic trait and an efficacy of treatment with a medicament;
receive an inquiry related to a medicament; and
provide a human readable output comprising a relationship between the genetic attributes of the multiple individuals and the medicament.
